(19) United States
(12) Patent Application Publication
(10) Pub. No.: US 2026/0022683 A1
(43) Pub. Date: Jan. 22, 2026

(54) GAS FUEL INJECTOR

(71) Applicant: Nikki Co., Ltd., Kanagawa-ken (JP)

(72) Inventors: Tsutomu Murakami, Kanagawa-ken (JP); Shutaro Aizawa, Kanagawa-ken (JP); Naokazu Kaneko, Kanagawa-ken (JP)

(21) Appl. No.: 19/273,113

(22) Filed: Jul. 17, 2025

(30) Foreign Application Priority Data
Jul. 18, 2024 (JP) P2024-114974

(51) Int. Cl. F02M 51/06

(52) U.S. Cl. CPC F02M 51/0632; F02M 2200/16

(57) ABSTRACT

A gas fuel injector is provided, comprising a main body with an internal fuel passage, an opening/closing valve, and a solenoid for actuating the valve. The valve includes a shaft with a proximal end fixed to a solenoid plunger, a valve body at the distal end, and a valve seat member facing the valve body. The valve seat member includes a central valve hole, an annularly projecting peripheral wall, and an annular seat surface at the distal end of the wall. The valve body includes a sealing surface with a tapered, arched, or spherical shape that contacts the seat surface when the valve is closed.

### CROSS-REFERENCE TO RELATED APPLICATION

This application claims priority to Japanese Patent Application No. P2024-114974, filed on Jul. 18, 2024, the contents of which is hereby incorporated by reference in its entirety.

### TECHNICAL FIELD

The present disclosure relates to a normally-closed gas fuel injector for injecting gas fuel such as hydrogen gas, LPG, and CNG directly into a cylinder at a flow rate required by an engine driven by the gas fuel.

### BACKGROUND

Conventionally, there is widely known an electromagnetically-driven injector that operates an opening/closing valve by exciting an electromagnetic coil to inject fuel into a cylinder at a flow rate required by an engine.

Such an opening/closing valve (electromagnetic valve) is classified into a normally-open type or a normally-closed type. In addition, the opening/closing valve is also classified into either a type in which the valve is closed by pressing a valve body against a valve seat (for example, see JP 2005-256638 A), or a type in which the valve is closed by attracting the valve body to the valve seat (for example, see JP H11-280605 A).

In a valve structure disclosed in JP H11-280605 A, an internal annular surface of a valve seat (port) and an external annular surface of a valve body come into sealing contact with each other while closing a nozzle. However, for example, in a case where the valve body tilts due to oscillation of a valve shaft at the time of opening/closing operation or the like, a gap is easily formed between the valve seat and the valve body. Thus, there has been an issue that it is likely to be difficult to ensure the airtightness between the inside and the outside.

### SUMMARY

The present disclosure is intended to solve the above issue, and an object thereof is to provide a gas fuel injector including a normally-closed opening/closing valve, in which it is possible to prevent fuel leakage while the valve is closed even in a case where a pressure in a cylinder into which fuel is injected becomes excessively high or a valve body tilts.

In view of the above, the present disclosure provides a gas fuel injector that is a normally-closed electromagnetically-driven type and injects gas fuel directly into a cylinder of an engine, the gas fuel injector including: a main body having a fuel passage formed inside; an opening/closing valve that is disposed in the main body and is configured to open and close the fuel passage; and a solenoid that is disposed in the main body and is configured to drive the opening/closing valve to open during energization,
wherein the opening/closing valve includes: a valve shaft of which proximal end side is fixed to a plunger constituting the solenoid; a valve body provided on a distal end side of the valve shaft; and a valve seat member disposed in the main body to face the valve body,
wherein the valve seat member includes: a valve hole penetrating a center of the valve seat member; a peripheral wall formed to protrude annularly at a predetermined height along an outer periphery of an opening of the valve hole; and a seat surface having an annular shape that is formed at a distal end portion of the peripheral wall, and
the valve body includes: a sealing surface having a tapered shape, an arch shape, or a spherical shape to be in contact with the seat surface when the opening/closing valve is closed.

As described above, regarding the valve seat member and the valve body constituting the opening/closing valve in the normally-closed gas fuel injector, the seat surface of the valve seat member is formed at the distal end portion of the peripheral wall protruding annularly, and the sealing surface of the valve body is formed in a tapered shape, an arch shape, or a spherical shape with the center axis of the valve shaft as the center line. Therefore, even in a case where the valve body tilts due to oscillation of the valve shaft at the time of valve closing, it is possible to correct the tilt of the valve body and perform alignment with the valve closing operation because of the shapes of the seat surface and the sealing surface, to avoid generation of a gap between the seat surface and the sealing surface, and to prevent fuel leakage while the valve is closed.

In the present disclosure, the seat surface is formed at the distal end portion of the peripheral wall protruding annularly at the predetermined height along the outer periphery of the opening of the valve hole, and an outer edge side and an inner edge side of the distal end portion may be chamfered so that a longitudinal cross-section of the seat surface has a semicircular shape. With this configuration, when alignment is performed with the inclined sealing surface of the valve body in contact with the seat surface during the valve closing operation, alignment operation is carried out while the inclined sealing surface smoothly slides on the seat surface having chamfered corners, and moreover the combination of the curved surfaces makes it easier to ensure close contact between the seat surface and the sealing surface on a constant basis.

In the present disclosure, the opening/closing valve may be an outwardly-opening type, and the valve body may be disposed to protrude outside the valve hole and may be shaped such that a side with the sealing surface protrudes in a direction toward the proximal end side of the valve shaft. With this configuration, even in a case where an in-cylinder pressure excessively increases, a biasing force in a valve closing direction due to the high in-cylinder pressure in combination with the inclined surface of the sealing surface of the valve body results in a further increase in a degree of the close contact with the seat surface because of the outwardly-opening structure of the opening/closing valve, and thus fuel leakage can be easily further prevented.

According to the present disclosure, it is possible to enhance alignability and sealing properties of a valve body to effectively prevent fuel leakage while a valve is closed.

### BRIEF DESCRIPTION OF DRAWINGS

FIG. 1 is a longitudinal cross-sectional view illustrating a first embodiment of a gas fuel injector according to the present disclosure;

FIG. 2 is an enlarged longitudinal cross-sectional view of an opening/closing valve portion in the embodiment illustrated in FIG. 1;

FIG. 3 is an enlarged perspective partial cross-sectional view of the opening/closing valve portion in the embodiment illustrated in FIG. 1;

FIG. 4 is a longitudinal cross-sectional view illustrating a second embodiment of a gas fuel injector according to the present disclosure; and

FIG. 5 is a longitudinal cross-sectional view illustrating a third embodiment of a gas fuel injector according to the present disclosure.

### DETAILED DESCRIPTION

Hereinafter, embodiments of the present disclosure will be described with reference to the drawings. Note that, in the present disclosure, gas fuel refers to fuel that is supplied to an engine in a gas state and burned, such as LPG, CNG, LNG, and hydrogen gas.

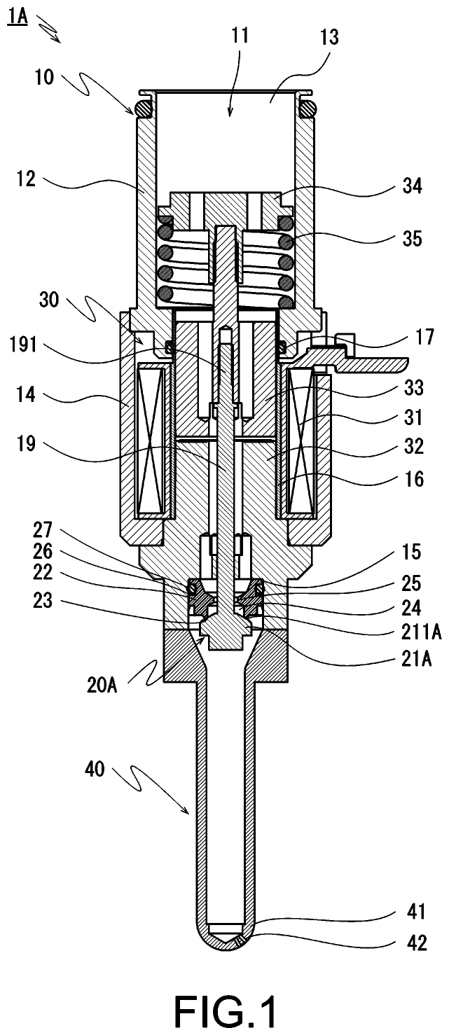

FIG. 1 is a longitudinal cross-sectional view illustrating a first embodiment of a gas fuel injector in a valve closed state according to the present disclosure.

A gas fuel injector 1A of the present embodiment includes, in a cylindrical main body 10 having a fuel passage 11 leading from a fuel inlet 13 on a proximal end side, an opening/closing valve 20A that opens and closes the fuel passage 11 and a solenoid 30 that drives the opening/closing valve 20A to open during energization. The gas fuel injector 1A is a device for supplying gas fuel, of which pressure is reduced and adjusted to a predetermined pressure, into a cylinder of an engine (not illustrated) at a flow rate required by the engine.

When the gas fuel injector 1A is used, an electromagnetic coil 31 of the solenoid 30 is energized and excited, so that a fixed iron core 32 attracts a plunger (movable iron core) 33 and opens the opening/closing valve 20A, and the gas fuel that has passed through the opening/closing valve 20A is injected directly into the cylinder of the engine from an injection hole 42 opened at a distal end 41 of a nozzle 40. The gas fuel injector 1A is a normally-closed electromagnetically-driven injector.

The main body 10 includes a cylindrical inlet body 12 having the fuel inlet 13 and an outlet body 14 having a valve seat member holder 15, which are formed of a magnetic material such as metal.

A collar member 16 for positioning and sealing used in combination with an O-ring 17 is provided inside the inlet body 12 and the outlet body 14.

The opening/closing valve 20A includes a valve body 21A and a valve seat member 22, which are formed as separate components from the main body 10. The opening/closing valve 20A is a poppet-type valve in which the valve body 21A is driven perpendicularly with respect to the valve seat member 22.

The valve body 21A is provided on a distal end side of a valve shaft 19 of which proximal end 191 side is fixed to the plunger 33, and performs a reciprocating motion in an axial direction with the valve shaft 19.

The valve body 21A is made of metal and is formed integrally with the valve shaft 19.

The valve seat member 22 is held by the valve seat member holder 15 and is disposed so as to face the valve body 21A. The valve seat member 22 includes a seat surface 23 in contact with or separate from a sealing surface 211A of the valve body 21A, a valve hole 24 penetrating a central portion, and an orifice 25 for flow rate measurement formed to be narrowed at an intermediate position of the valve hole 24.

The valve seat member 22 has a recessed groove 26 that is formed on an outer peripheral surface and in which an O-ring 27 is mounted, so that an outer peripheral side is in airtight contact with the main body 10.

The valve seat member 22 is made of a polymer material, and in particular preferably a resin material.

The solenoid 30 includes the electromagnetic coil 31, the fixed iron core 32 located inside the electromagnetic coil 31, the plunger 33 provided to face the fixed iron core 32, a spring guide 34, and a coil spring 35. All the components constituting the solenoid 30 are coaxially arranged.

As described above, in the present embodiment, the opening/closing valve 20A is configured such that the valve body 21A that performs a reciprocating motion in the axial direction is provided on the distal end side of the valve shaft 19 of which proximal end 191 side is fixed to the plunger 33 constituting the solenoid 30, and that the annular seat surface 23 in contact with or separate from the sealing surface 211A formed on a proximal end side of the valve body 21A is provided on an outer periphery of an opening of the valve hole 24 penetrating the valve seat member 22.

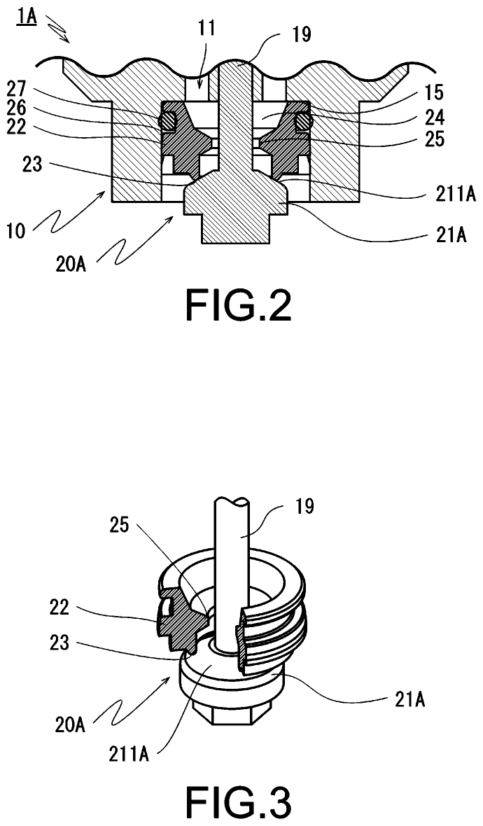

Further, in the valve body 21A, as illustrated in a longitudinal cross-sectional view of FIG. 2 in which the opening/closing valve 20A is partially enlarged, the sealing surface 211A including a portion to be in contact with the seat surface 23 when the valve is closed is formed in a tapered shape (truncated cone shape) of which center line coincides with center axes of the plunger 33 and the valve shaft 19. Thus, even when the valve body 21A comes into contact with the seat surface 23 in a tilted state at the time of valve closing, the valve body 21A is guided by the inclination of the tapered sealing surface 211A to be aligned.

That is, in the normally-closed gas fuel injector 1A of the present embodiment, the sealing surface 211A of the valve body 21A that constitutes the opening/closing valve 20A and includes the portion to be in contact with the seat surface 23 is formed in a tapered shape of which center line coincides with the center axis of the valve shaft 19, which makes it possible to avoid generation of a gap between the sealing surface 211A of the valve body 21A and the seat surface 23 of the valve seat member 22 at the time of valve closing and to reliably prevent fuel leakage.

In addition, in the present embodiment, as illustrated in a perspective partial cross-sectional view of FIG. 3 in which a portion of the opening/closing valve 20A is enlarged, the seat surface 23 is formed at a distal end portion of a peripheral wall protruding annularly at a predetermined height along the outer periphery of the opening of the valve hole 24 of the valve seat member 22, and an outer edge side and an inner edge side of the distal end portion are chamfered so that a longitudinal cross-section has a semicircular shape.

With this configuration, alignment is performed on the valve body 21A tilted at the time of valve closing with the sealing surface 211A in contact with the annular seat surface 23 having a longitudinal cross-section of a semicircular shape.

Therefore, even when a contact angle between the sealing surface 211A and the seat surface 23 changes while the sealing surface 211A slides on the seat surface 23, the combination of the curved surfaces can realize smooth alignment operation while keeping a close contact state between the sealing surface 211A and the seat surface 23, and enhance sealing performance when the valve is closed.

Furthermore, in the gas fuel injector 1A of the present embodiment, as illustrated in FIG. 1, the valve body 21A is provided on the distal end side of the valve shaft 19 penetrating the valve hole 24, and the valve body 21A is disposed to protrude to a portion outside the valve hole 24 and is shaped such that a side with the sealing surface 211A that comes into contact with the seat surface 23 protrudes in a direction toward the proximal end side of the valve shaft 19, which means that an outwardly-opening structure (check valve structure) is adopted for the opening/closing valve.

By adopting such a check valve structure, even if an in-cylinder pressure excessively increases, the valve body 21A is just biased in a direction toward the seat surface 23, and thus fuel leakage can be easily further minimized.

In addition, as described above, since the valve body 21A is formed such that the side with the sealing surface 211A that faces the seat surface 23 protrudes in a truncated cone shape, the biasing force in the valve closing direction due to the high in-cylinder pressure in combination with the shape of the sealing surface 211A results in a further increase in the degree of the close contact with the seat surface 23 together with alignment of the valve body 21A, and thus fuel leakage can be easily further prevented.

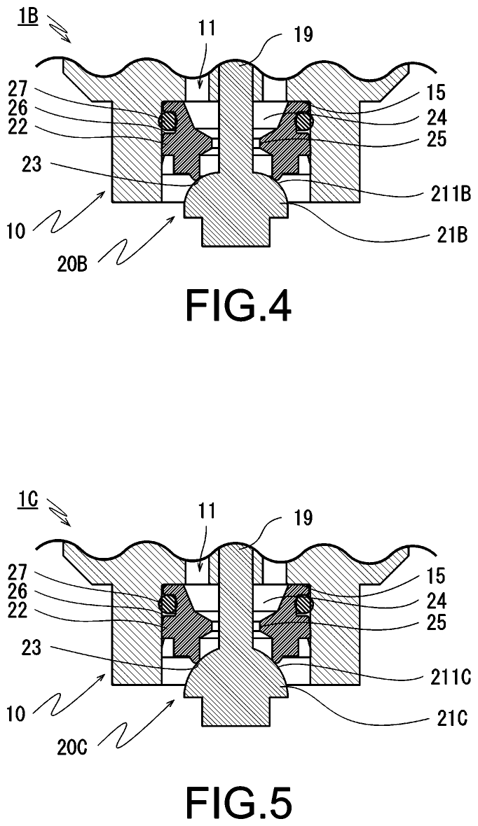

FIG. 4 is an enlarged longitudinal cross-sectional view of a portion of an opening/closing valve 20B in a gas fuel injector 1B according to a second embodiment as a modification example of the above-described gas fuel injector 1A. Note that the same components as those of the gas fuel injector 1A are denoted by the same reference signs, and the description thereof will be omitted.

This modification example is a sealing surface 211B of a valve body 21B constituting the opening/closing valve 20B is formed in a spherical shape.

More specifically, the sealing surface 211B corresponds to a surface of a rotating body, which is drawn by rotating, about the central axis of the valve shaft 19, an arc of a sector having a central angle of 90 degrees disposed such that one radius is parallel to the central axis of the valve shaft 19 at a certain distance perpendicularly away from the central axis of the valve shaft 19 and that the arc faces toward the seat surface 23.

With this configuration, similarly to the above-described tapered sealing surface 211A, a surface side to be in contact with the seat surface 23 is inclined with a diameter decreasing as it protrudes. Therefore, even when the valve body 21B comes into contact with the seat surface 23 in a tilted state at the time of valve closing, the valve body 21B is guided by the inclination of the spherical sealing surface 211B to be aligned.

In addition, since the sealing surface 211B of the valve body 21B has a spherical shape, when alignment is performed on the valve body 21B that has tilted due to oscillation of the valve shaft 19, the valve body 21B can correct the tilt of the valve shaft 19 while rotating with the seat surface 23 in close contact with the sealing surface 211B.

Also in the present embodiment, the annular seat surface 23 has a longitudinal cross-section of a semicircular shape, leading to a configuration in which the spherical surface of the sealing surface 211B of the valve body 21B and the curved surface of the seat surface 23 are in contact with each other.

Therefore, sliding with contact between these curved surfaces can achieve smoother alignment operation, and wear of the contact surfaces is easily minimized.

FIG. 5 is an enlarged longitudinal cross-sectional view of a portion of an opening/closing valve 20C in a gas fuel injector 1C according to a third embodiment as a modification example of the above-described gas fuel injector 1A. Note that the same components as those of the gas fuel injector 1A are denoted by the same reference signs, and the description thereof will be omitted.

This modification example is a sealing surface 211C of a valve body 21C constituting the opening/closing valve 20C is formed in a spherical shape.

More specifically, the sealing surface 211C corresponds to a part of a surface of a rotating body, which is drawn by rotating, about the central axis of the valve shaft 19, an arc of a sector having a central angle of 90 degrees disposed such that one radius coincides with the central axis of the valve shaft 19 and that the arc faces toward the seat surface 23.

With this configuration, similarly to the above-described tapered sealing surface 211A, a surface side to be in contact with the seat surface 23 is inclined with a diameter decreasing as it protrudes. Therefore, even when the valve body 21C comes into contact with the seat surface 23 in a tilted state at the time of valve closing, the valve body 21C is guided by the inclination of the spherical sealing surface 211C to be aligned.

In addition, since the sealing surface 211C of the valve body 21C has a spherical shape, when alignment is performed on the valve body 21C that has tilted due to oscillation of the valve shaft 19, the valve body 21C can correct the tilt of the valve shaft 19 while rotating with the seat surface 23 in close contact with the sealing surface 211C.

Also in the present embodiment, the annular seat surface 23 has a longitudinal cross-section of a semicircular shape, leading to a configuration in which the spherical surface of the sealing surface 211C of the valve body 21C and the curved surface of the seat surface 23 are in contact with each other.

Therefore, sliding with contact between these curved surfaces can achieve smoother alignment operation, and wear of the contact surfaces is easily minimized.

The shape of a sealing surface may be an axisymmetric shape that converges toward the central axis of the valve shaft 19 with its vertex directed toward the valve seat member 22. In the first embodiment, a tapered shape (truncated cone shape) is adopted, and in the second embodiment and the third embodiment, a spherical shape is adopted. In other cases, for example, an arch shape may be adopted.

As described above, according to the present disclosure, in a gas fuel injector including a normally-closed opening/closing valve, it is possible to reliably prevent fuel leakage while the valve is closed even in a case where a pressure in a cylinder becomes excessively high or a valve body tilts.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

What is claimed is:

1. A gas fuel injector, comprising:
a main body defining a fuel passage therein;
an opening/closing valve disposed in the main body and configured to open and close the fuel passage; and
a solenoid disposed within the main body and configured to drive the opening/closing valve to open upon energization,
wherein the opening/closing valve comprises:
a valve shaft having a proximal end fixed to a plunger of the solenoid;
a valve body provided on a distal end of the valve shaft; and
a valve seat member disposed in the main body and facing the valve body,
wherein the valve seat member comprises:
a valve hole extending through a center portion of the valve seat member;
a peripheral wall projecting annularly to a predetermined height along an outer periphery of an opening of the valve hole; and
a seat surface having an annular shape located at a distal end portion of the peripheral wall,
wherein the valve body comprises:
a sealing surface having a tapered, arched, or spherical shape configured to contact the seat surface when the opening/closing valve is in a closed position.

2. The gas fuel injector according to claim 1, wherein an outer edge and an inner edge of the seat surface are chamfered such that a longitudinal cross-section of the seat surface is substantially semicircular.

3. The gas fuel injector according to claim 1, wherein the valve seat member is made of resin.

4. The gas fuel injector according to claim 1, wherein the opening/closing valve is an outwardly-opening type, wherein the valve body is configured to protrude outwardly from the valve hole, and wherein the sealing surface of the valve body is shaped to project in a direction toward the proximal end of the valve shaft.

5. The gas fuel injector according to claim 2, wherein the opening/closing valve is an outwardly-opening type, wherein the valve body is configured to protrude outwardly from the valve hole, and wherein the sealing surface of the valve body is shaped to project in a direction toward the proximal end of the valve shaft.

6. The gas fuel injector according to claim 3, wherein the opening/closing valve is an outwardly-opening type, wherein the valve body is configured to protrude outwardly from the valve hole, and wherein the sealing surface of the valve body is shaped to project in a direction toward the proximal end of the valve shaft.

7. The gas fuel injector according to claim 1, wherein the gas fuel injector is configured as a normally-closed, electromagnetically-actuated injector and is adapted to inject gas fuel directly into a cylinder of an engine.

8. The gas fuel injector according to claim 2, wherein the gas fuel injector is configured as a normally-closed, electromagnetically-actuated injector and is adapted to inject gas fuel directly into a cylinder of an engine.

9. The gas fuel injector according to claim 3, wherein the gas fuel injector is configured as a normally-closed, electromagnetically-actuated injector and is adapted to inject gas fuel directly into a cylinder of an engine.

10. The gas fuel injector according to claim 4, wherein the gas fuel injector is configured as a normally-closed, electromagnetically-actuated injector and is adapted to inject gas fuel directly into a cylinder of an engine.

11. The gas fuel injector according to claim 5, wherein the gas fuel injector is configured as a normally-closed, electromagnetically-actuated injector and is adapted to inject gas fuel directly into a cylinder of an engine.

12. The gas fuel injector according to claim 6, wherein the gas fuel injector is configured as a normally-closed, electromagnetically-actuated injector and is adapted to inject gas fuel directly into a cylinder of an engine.

13. The gas fuel injector according to claim 1, wherein the valve seat member comprises resin.
